(19) United States
(12) Patent Application Publication
(10) Pub. No.: US 2021/0359454 A1
(43) Pub. Date: Nov. 18, 2021

(54) ELECTRICAL PLUG CONNECTOR

(71) Applicant: WEIDMÜLLER INTERFACE GMBH & CO. KG, Detmold (DE)

(72) Inventors: Jörg MÜNSTERMANN, Schlangen (DE); Heike SCHMIDTPOTT, Bad Salzuflen (DE)

(21) Appl. No.: 17/271,371

(22) PCT Filed: Sep. 25, 2019
(86) PCT No.: PCT/EP2019/075813

§ 371 Date: Jul. 23, 2021

(30) Foreign Application Priority Data
Sep. 26, 2018 (DE) 20 2018 105 524.0

(51) Int. Cl. H01R 13/426

(52) U.S. Cl. CPC H01R 13/426

(57) ABSTRACT

An electrical plug connector (10) with a plug face (105) which is provided for connecting the electrical plug connector (10) to a mating plug connector, an electrical contact (1) which is provided for connecting an electrical conductor (4) to an electrical plug connector (10) and which comprises a spring cage (11) with a clamping spring (2) acting as a pressure spring and with a busbar contact region (13) opposite the clamping spring (2), and a single-part or multipart connection housing (6) which is designed to accommodate the contact (1), wherein it is provided moreover to latch the clamping spring (2) in a latching state in open position, wherein this latching and open position can be brought out of engagement at least by inserting the conductor, characterized in that the plug connector (10) includes a release element (3) which is provided for releasing the electrical conductor (4) out of the contact (1) so that the conductor (4) can be removed from the plug connector (10), wherein the release element (3) is integrated in the plug connector (10).

The present invention relates to an electrical plug connector according to the preamble of claim 1.

Published document WO 2012/163692 discloses such an electrical plug connector according to the preamble, which comprises a retaining means for positioning the clamping spring in an open initial state. When the electrical conductor is inserted, the retaining means can be shifted together with said electrical conductor. Here, the conductor cannot be released again from the plug connector.

The aim of the present invention therefore is to improve the plug connector according to the preamble so that the conductor, after the insertion and clamping in the plug connector, can be easily and rapidly released again from said plug connector.

The aim is achieved with an electrical plug connector having the features of independent claim 1. Advantageous embodiments can be obtained from the dependent claims.

Created according to claim 1 is an electrical plug connector with a plug face which is provided for connecting the electrical plug connector to a mating plug connector, with an electrical contact in the sense of a connection device provided for connecting an electrical conductor to the electrical plug connector, and which comprises a spring cage with a clamping spring acting as a pressure spring and a busbar contact region opposite the clamping spring, and with a connection housing which is formed for accommodating the contact, wherein it is provided moreover to latch the clamping spring in a latching state in open position, wherein this latching and open position can be brought out of engagement at least by inserting the conductor, wherein the plug connector includes a release element which is provided for releasing—in particular manually without a tool or actuated with a tool—the electrical conductor from the contact, so that the conductor, after the release element has been actuated, can be removed from the plug connector, wherein the release element is integrated in the plug connector. The term latching state should not be interpreted too narrowly but rather also covers constructions in which the clamping spring is pressed into an open state or held in another manner in such an open state.

The electrical plug connector is thus characterized in that it includes the release element which is provided for releasing, in particular without a tool or actuated with a tool, the electrical conductor from the contact, so that, during or after the actuation of the release element, the conductor can be removed from the plug connector. In spite of the very cramped installation space conditions of the plug connector according to the preamble, the integration of the release element in the electrical plug connector can surprisingly be achieved. This allows the release of the electrical conductor from the contact. Preferably, the clamping spring can be released from the conductor, in particular taken off of it, by means of the release element. Thereby, not only can the electrical conductor be removed easily and rapidly from the plug connector, but also the removal of the electrical conductor from the plug connector can be performed by an untrained person with the help of the release element.

Particularly preferably, the electrical conductor can be released from the contact without a tool by means of the release element. However, also preferred are embodiments which provide a tool-actuated release of the electrical conductor from the contact.

In terms of construction, the release element can be provided in different ways, such as, for example, advantageously as a pressing element or push button or as a pivot element. Here, it is advantageous if the release element protrudes from a housing, in particular axially, directly or via an intermediate element such as a slider by means of which it can be actuated.

According to a first easily implemented variant, the release element can be formed or arranged on a slider, in particular a slider which can be shifted parallel to a conductor insertion opening, and can be moved via said slider or with said slider. With the slider, via the release element or its release region, the clamping spring can be set back into an open state. However, it is also conceivable to form the release element as a pivot element or on such a pivot element.

The release element can also be provided in an arrangement so as to latch the clamping spring in a latching state in open position, wherein this latching and open position can be released at least by inserting the conductor—but preferably also by the release element.

Here, the release element can be formed or arranged on a shiftable sleeve which forms the slider, in particular on a sleeve which protrudes axially from the plug conductor, so that it can be easily actuated or moved. In this way, the release element is integrated particularly satisfactorily and in a space-saving manner in the plug connector or its housing, in particular if the sleeve in the process is also used for passing the conductor into the contact site/clamping site of the clamping cage.

In this way, the slider can be formed as a sleeve or in a fundamentally different manner so that the electrical conductor can be inserted into said slider, and the slider can include a conductor accommodation for accommodating the conductor, wherein the conductor accommodation can advantageously be arranged between the busbar contact region and the clamping spring of the contact. It is precisely in the case of a design of the plug connector for connecting only a single conductor that the design of the slider as a sleeve, in particular as a sleeve which is circumferentially closed at least in sections, is advantageous, especially since the sleeve can be accommodated very satisfactorily in a compact manner on such a plug connector. In fact, a sleeve on such a plug connector as a means for assisting the wiring and insertion is already known per se. However, it was not recognized that, in a development, optionally in combination with the release element, this sleeve is also suitable as an actuation element for releasing the conductor, so that the plug connector according to the preamble can essentially be reused.

Preferably, the slider can be shifted from a delivery state, in which the electrical conductor can be inserted into the spring cage, into a connection state, in which the clamping spring is in contact with the electrical conductor and clamps said electrical conductor in the spring cage, the slider is preferably shiftable. Particularly advantageously, the plug connector can be transferred back into the delivery state by means of the release element. As a result, the plug connector can be directly reused. Consequently, the costs of a new electrical plug connector can be saved.

In terms of construction and for an easy handling in the sense of a quick conductor connection and/or conductor exchange, it is advantageous if the slider-like release element is mounted in a shiftable manner in the contact on the conductor insertion side of the spring cage. Here, the conductor can be released again from the plug connector in a particularly simple way by an additional shifting of the slider by means of the release element in the conductor insertion direction. The release element of this embodiment can be formed as a plate. Particularly preferably, it extends at least partially in the conductor insertion direction.

However, in the case of a release element formed as a plate, said release element can also be formed or provided so that it can be moved, in particular shifted, in the plug connector by means of a tool. The conductor can then be released from the plug connector preferably by actuating the plate in the conductor insertion direction by means of the tool, for example, a screwdriver.

In addition, the release element made of a plate can also extend at least partially in a release direction transverse to the conductor insertion direction. In this embodiment, the conductor can preferably be released from the plug connector by shifting the plate in the release direction.

All these embodiments with a release element made of a plate have in common the fact that at least the clamping arm of the clamping spring is taken off of the conductor when the plate is shifted and that the conductor can then be removed from the plug connector by pulling out against the conductor insertion direction.

In another advantageous embodiment, a part of the clamping spring forms the release element. Particularly preferably, the clamping spring comprises two spring arms, wherein the first of the two spring arms includes a free arm end which is used for clamping the electrical conductor in the clamping cage. In this embodiment, the second of the two spring arms is preferably formed as release means. The clamping spring of this embodiment can preferably be rotated about a rotation axis. Preferably, when the second spring arm forming the release element is actuated in a rotation direction, the clamping spring rotates so that a conductor inserted into the plug connector is clamped. On the other hand, when the second spring arm is actuated against the rotation direction, the conductor which is inserted into the plug connector is released. This embodiment too allows a very rapid and easy connection or exchange of the electrical conductor.

In a preferred design, the plug connector can be provided only for connecting a single conductor. In an additional preferred design, the plug connector can be designed as a circular plug connector.

Additional advantageous designs can be obtained from the remaining dependent claims.

Below, the invention is described in further detail in reference to the drawings using embodiment examples, wherein additional advantages of the invention become clear. The embodiment examples should be understood to be only exemplary and not limiting. In the drawings:

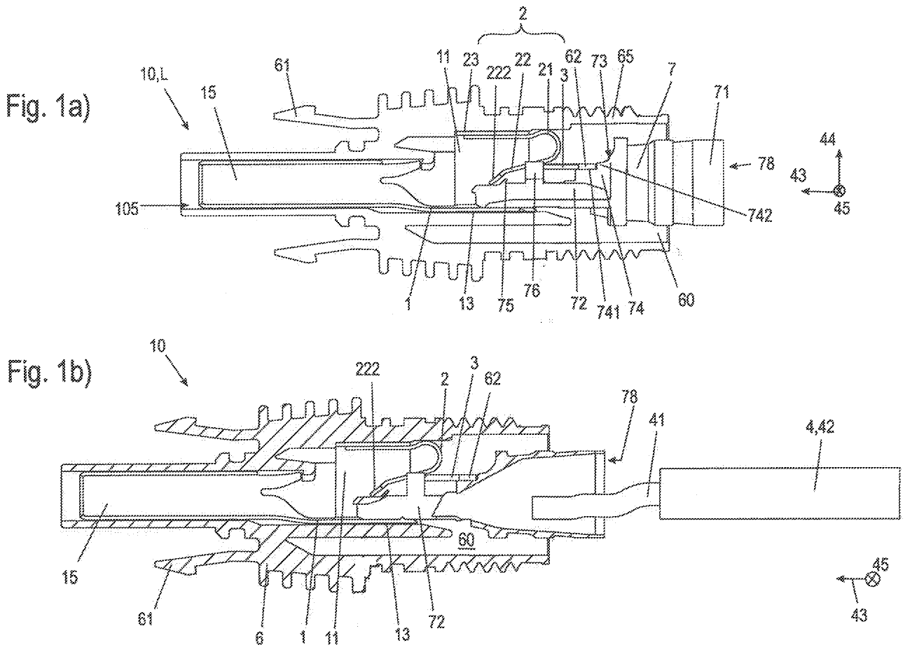

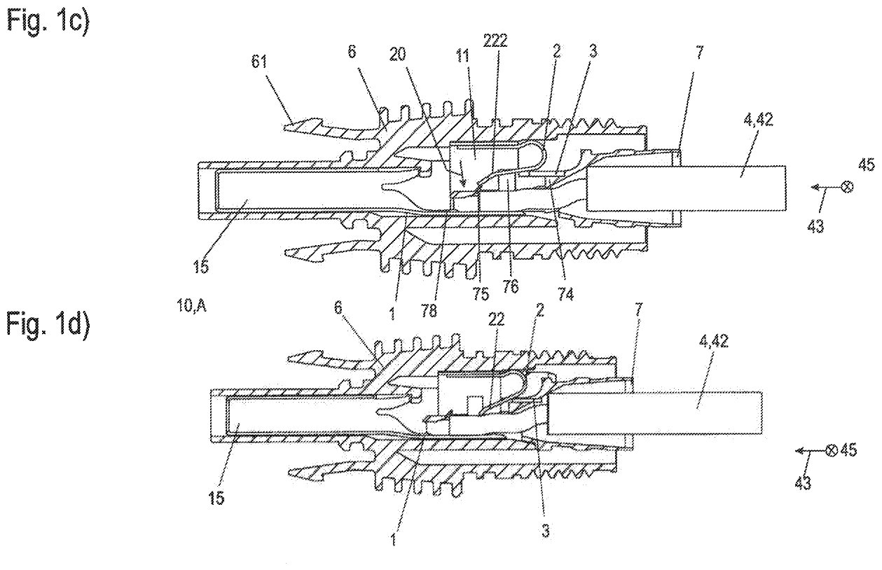

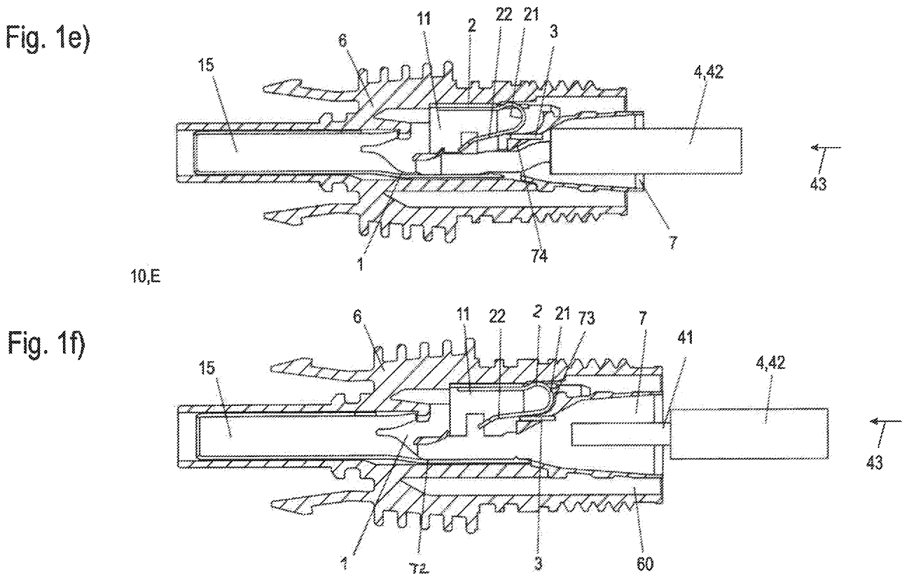

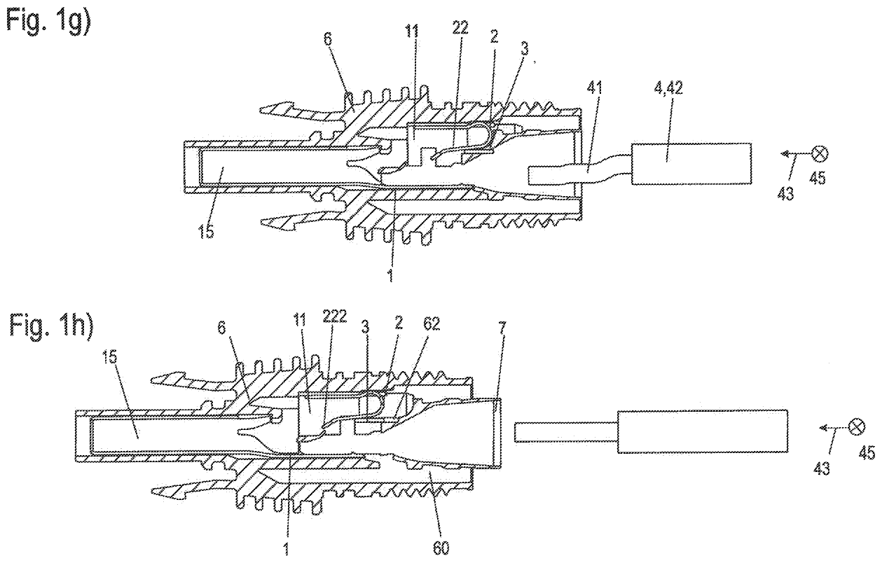

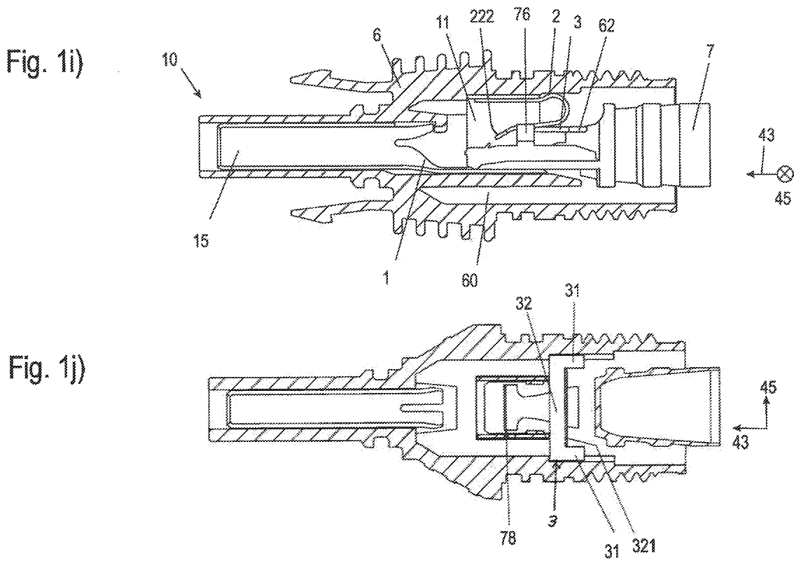

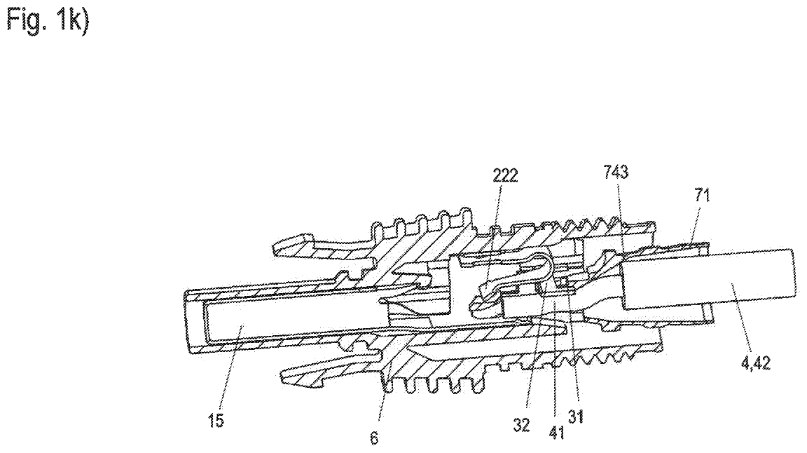

FIG. 1 shows in a)-e) the clamping and in f)-i) the release of an electrical conductor in a first embodiment of an electrical plug connector according to the invention, and in j) a view of the plug connector rotated by 90°, and in k) a perspective view of the process of a conductor insertion;

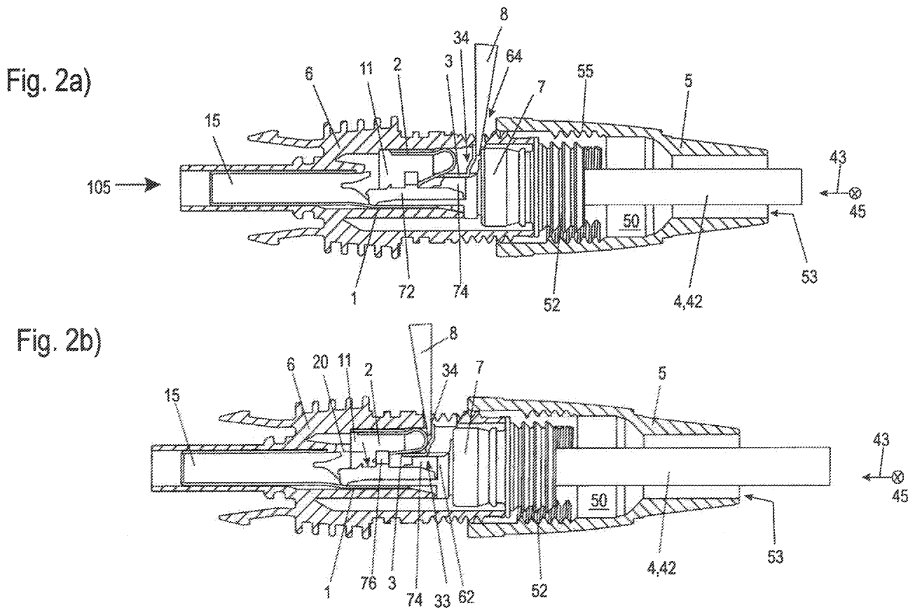

FIG. 2-5 in each case show an additional embodiment of an electrical plug connector according to the invention, wherein, in a) and b), respective different states are shown.

FIG. 1, in a)-e), shows the clamping and contacting of an electrical conductor 4, and, in f)-i), the release of the electrical conductor 4 from a first embodiment of an electrical connector 10 according to the invention, and, in j), a view of the plug connector 10 rotated by 90°.

The plug connector 10 comprises an electrical contact 1 in the sense of a conductor connection device which is provided and formed for connecting the electrical conductor 4 to the plug connector 10. The contact 1 can include a spring cage 11, in which a clamping spring 2 is secured, which acts as a pressure spring during the contacting. The spring cage 11 can be formed in its entirety or in sections from a satisfactorily conductive busbar material. The clamping spring 2 can be designed as V-shaped. It comprises a first spring arm 22 which comprises a free arm end 222 which is provided for clamping the electrical conductor 4 in the spring cage 11 (clamping arm). It also comprises a second spring arm 23 which is arranged opposite the first spring arm 22. For this purpose, the clamp spring 2 has a bend 21. As a result, the first and the second spring arms 22, 23 extend in the shape of a V (release state) or, in the contact state, even almost parallel to one another. The second spring arm 23 can be secured on the spring cage 11. Such contacts are also referred to as direct plug connections or push-in connections.

Moreover, the plug connector 10 comprises a plug face 105 which is provided for connecting the plug connector 10 to a mating plug connector, not represented. For this purpose, the contact 1 can be conductively connected to a contact sleeve 15 which forms a socket and which is provided for accommodating a contact plug (not shown) of the mating plug connector. In an alternative embodiment, the contact 1 can also be connected with a contact plug (not shown) which is provided for insertion into a contact sleeve (not shown) of the mating plug connector.

The contact 1 is arranged in an inner space 60 of a plug connector housing or connection housing 6. The connection housing 6 can comprise latching hooks 61, by which the plug connector 10 can be fastened to the mating plug connector. In addition, the connection housing 6 here jackets the contact sleeve 15 of the contact 1. The contact sleeve 15 or the contact plug or pin, together with the jacket of the housing 6 or connection housing 6, forms the plug face 105 of the plug connector 10.

In addition, the plug connector 10 can comprise a slider 7. The slider 7 can be arranged on the side (not designated) of the contact 1 opposite the contact sleeve 15 and can be inserted into the contact. The slider can also be arranged in sections in the inner space 60 of the connection housing 6 and protrude axially from its end.

The electrical conductor 4 can be inserted into the slider 7. For this purpose, the slider 7 can comprise a conductor accommodation 72, in particular a groove-like conductor accommodation, which is provided for accommodating the conductor 4.

The slider 7 can moreover comprise a sleeve 71 which can comprise a conductor insertion opening 78 through which the conductor 4 can be inserted into the conductor accommodation 72 from the open end of the connection housing 6 in the conductor insertion direction 43.

The electrical conductor 4 comprises an electrically conductive core 41 which can be designed as a solid conductor or as a stranded conductor. The core 41 is jacketed with an electrically insulating jacket 42. For the connection of the electrical conductor 4 to the plug connector 10, the conductor is stripped of insulation on a free end (not designated), and the stripped end is inserted through the sleeve 71 into the conductor accommodation 72, so that at least a short portion of the jacket 42 is surrounded by the sleeve 71. Thereby, the sleeve 71 and the jacket 42 form a contact protection for an operator. The sleeve 71 is designed in sections like an insertion funnel against which the conductor insulation or jacket 42 abuts when the conductor is inserted, while the stripped end is inserted into the spring cage (see also FIG. 1k)).

The spring cage 11 in addition comprises a busbar contact region 13—designed, for example, as conductive busbar or directly as part of the spring cage—which is arranged opposite the clamping spring 2. The conductor accommodation 72 is arranged and can be shifted between the busbar contact region 13 and the clamping spring 2 of the contact 1. From a delivery state L of the plug connector 10, represented in (a), in which the electrical conductor 4 can be inserted into the spring cage 11, the slider 7 can be shifted in the conductor insertion direction 43, until, in a connection state A of the plug connector, the clamping spring 2 is in contact with the electrical conductor 4 and clamps said electrical conductor in the spring cage 11.

In addition, the plug connector 10 includes a release element 3. The release element 3 is provided for releasing the electrical conductor 4 from the contact 1, without a tool and/or actuated with a tool. By actuating the release element 3, the free arm end 222 of the first spring arm 22 of the clamping spring 2 can be taken off, so that the conductor 4 can be removed from the plug connector 10.

The release element 3 is here designed as a plate. It can be made of metal or else of another material. It extends in a plane (not designated) which is defined by the conductor insertion direction 43 and an extension direction 45 transverse to the conductor insertion direction. It is here mounted advantageously and simply in the connection housing 6 and arranged approximately parallel to a contact surface 742 provided on the slider. For this purpose, on opposite sides (not designated) of the connection housing 6, a link 62 is provided in each case. The release element 3 extends from one of the links 6 to the opposite link 62 and in each case rests thereon.

The connection housing 6 can be formed as a single part or in multiple parts, in particular in two parts. For this purpose, a sleeve-like housing end portion 5 (see FIG. 2-6) can be fastened on the sleeve-like connection housing 6. The sleeve-like housing end portion 5 can here be screwed or slidingly latched onto the connection housing 6. For this purpose, the connection housing 6 can comprise a thread 65, in particular an outer thread, and the sleeve-like housing end portion 5 can comprise a mating thread 55, in particular an inner thread.

For accommodating the conductor 4 as well as a portion of the slider 7, the sleeve-like housing end portion 5 comprises an inner space 50 (see FIG. 2). A conductor 4 fastened in the plug connector 10 extends through a conductor insertion opening 53 of the sleeve-like housing end portion 5, and the conductor insertion opening 78 of the sleeve 71 extends into the conductor accommodation 72.

FIG. 1a) shows the plug connector 10, in which the slider 7 is arranged in the delivery state L. In the delivery state, the clamping spring 2 is held in an open state. This can be implemented in a different manner. In the delivery state, preferably one or more means of the sleeve or of the slider 7 (thus, for example, according to a preferred variant, an end of the slider, which lies behind the contact web 75 in the conductor insertion direction) holds/hold the first spring arm 22 in an open position arranged or preloaded outside the conductor accommodation 72. As a result, the conductor 4 can be inserted into the conductor accommodation 72.

FIG. 1b) shows the plug connector 10 during the insertion of the electrical conductor 4 in the conductor insertion direction 43 through the conductor insertion opening 78 of the sleeve 71 into the conductor accommodation 72 of the slider 7. During the insertion into an end 78 of the conductor accommodation 72, the conductor 4 abuts on the inside against the sleeve 71 (for example, in an abutment region 743—reference numeral: FIG. 1k—or against the contact web 75), then takes the slider 7 along with it and, together with the latter, is moved or inserted further linearly and axially. FIG. 1c) and FIG. 1k) show this. Here, a support surface 741 of a supporting part 74 of the slider 7 lies under the release element 3.

The release element 3, represented in a top view in FIG. 1j), can be formed as approximately U-shaped. It can then comprise a cross web 32, on which, on the end side, a holding arm 31 can be arranged in each case. In the installed state (not designated), the holding arms 31 extend from the cross web 32 against the conductor insertion direction. Between the holding arms 31, an inner edge 321 of the cross web 32 extends.

When the slider 7 is shifted in the conductor insertion direction 43, the inner edge 321 is in contact with the contact surface 742 of the supporting part 74 which extends transversely to the support surface 741 of the supporting part 74. In addition, the tongues 76 are shifted along with it in the conductor insertion direction 43. The spring arm 22 is thus first in contact with the contact web 75 which extends in the extension direction 45 and is arranged on the conductor accommodation 72 of the slider. With further insertion, the free end of the clamping spring 2 slips beyond the contact web 75, until the first spring arm 22 of the clamping spring 2 is released. As a result, the first spring arm 22 can be turned by a resetting force of the clamping spring 2 in a clamping direction 20 toward the conductor accommodation 72. As a result, the clamping spring 2 is in contact with the electrical conductor 4, so that the conductor 4 is clamped in the plug connector 10. The slider 7 is then in the connection state shown in FIG. 1d).

In order to be able to release the electrical conductor 4 again and remove it from the plug connector 10, first the slider 7 is shifted further in the conductor insertion direction 43. FIG. 1e) shows this. Since the inner edge 321 is in contact with a contact surface 742 of the supporting part 74, the release element is moved along with it by the slider 7 in the process. The release element is then shifted under the first spring arm 22 of the clamping spring 2 and presses said arm against the clamping direction 20 and against the resetting force of the clamping spring 2 away from the conductor 4, until the bend 21 of the clamping spring 2 abuts against an abutment surface 73 of the slider 7. The plug connector 10 is now in the removal state E shown in FIG. 1f). In this state, the electrical conductor 4 can again be removed from the plug connector 10. The removal of the electrical conductor 4 is represented in FIG. 1g).

In order to transfer the electrical conductor 4 back into the delivery state L, the slider 7 is then pulled against the conductor insertion direction 43. Here, the first spring arm 22 firmly holds the release element 3 by means of the resetting force of the clamping spring 2, so that the release element is not pulled back with the slider 7 against the conductor insertion direction 43. FIG. 1h, i and j) show this.

Here, the tongues 76 are pulled back with the slider 7 against the conductor insertion direction 43, wherein the webs (not shown) are shifted under the first spring arm 22. Moreover, the free arm end 222 of the first spring arm is wider than the first spring arm 22. As a result, the free arm end 222 can finally lie again on the end of the slider 7 behind the contact web 75.

The plug connector 10 is now again in the delivery state L shown in FIG. 1a).

FIG. 2-6 show respective additional embodiments of electrical plug connectors 10 according to the invention, wherein in FIG. 2a, 3a, 4b, 5a, 6b, a connection state is shown, and in the other figures a release state is shown in each case.

The embodiments differ above all by the design of the release element 3. The release elements 3 of the plug connector 10 of FIG. 2-5 are in each case implemented as a plate and produced as stamped bent parts.

The plate used as release element 3 of FIG. 2 has a pressing section 34 extending transversely to the plane in which the cross web 32 is arranged. Between the pressing section 34 and the cross web 32, a step 33 can be provided for this purpose. The pressing section 34 can be actuated in particular with a tool, for example, a screwdriver 8.

FIG. 2, in (a), shows the plug connector 10 with the connection housing 6 and its sleeve-like housing end part 5. In order to be able to actuate the release element 3, a tool insertion opening 64, arranged in the region of the thread 65 of the connection housing 6, must be accessible. In FIG. 2a), the connection housing 6 is therefore slid only partially onto the sleeve-like housing end part 5. Thereby, the tool insertion opening 64 is accessible from outside.

In FIG. 2a), the electrical conductor 4 is clamped in the plug connector 10. The plug connector 10 is in a connection state. By actuating the pressing section 34 of the release element 3 with the screwdriver 8, said release element can be shifted along the links 62 of the connection housing 6 under the first spring arm 22, so that said first spring arm is taken off of the conductor 4. The release element 3 then presses the first spring arm 22 against the clamping direction 20 and against the resetting force of the clamping spring 2.

In FIG. 2b, on the other hand, the screwdriver 8 is inserted through the tool insertion opening 64 between the bend 21 of the clamping spring 2 and the pressing section 34 of the release element 3. In order to clamp the conductor 4, after the conductor 4 has been inserted into the plug connector 10 in the conductor insertion direction 43, the screwdriver 8 is turned. Since the screwdriver 8 is braced on the bend 21 of the clamping spring 2, the pressing section 34 is as a result shifted against the conductor insertion direction 43 and releases the first spring arm 22.

A very good protection against dust and moisture can be ensured in this plug connector 10 by an insulation insert 52 which is arranged in the sleeve-like housing end part 5. The insulation body 52 surrounds the sleeve 71 of the slider 7 as well as a portion of the electrical conductor 4 axially at least in sections to its full extent.

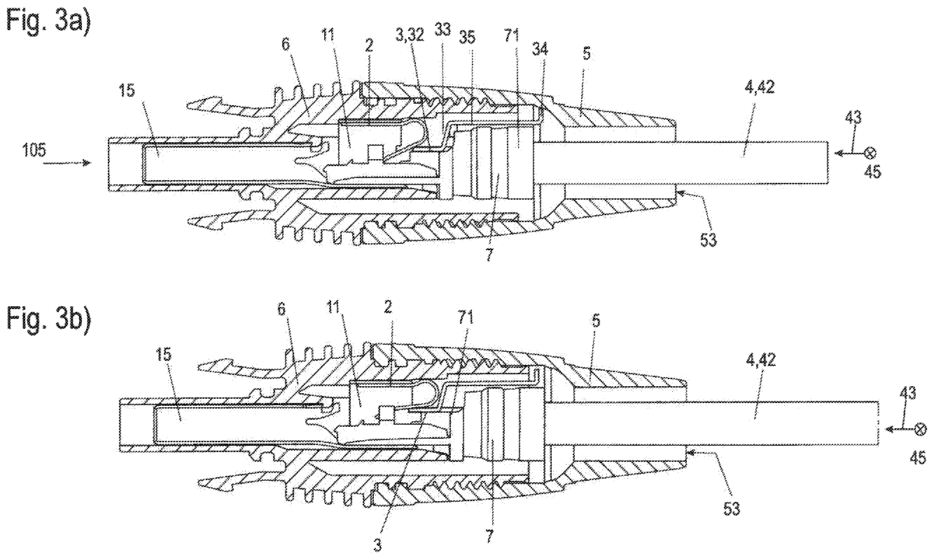

The release element 3 of the plug connector 10 of FIGS. 3a and 3b comprises an extension arm 35 which is connected, in particular analogously to the embodiment of FIGS. 2a and 2b, via a step 33 to the cross web 32. The step 33 is selected to be sufficiently large so that the extension arm 35 extends beyond the sleeve 71 and against the conductor insertion direction 43. The pressing section 34 is arranged on an end (not designated) of the release element 3 opposite the cross web 32. It extends transversely to the plane in which the cross web 32 is arranged.

This plug connector 10 can be actuated, in particular analogously to the plug connector 10 of FIG. 1, by shifting the slider 7 in and against the conductor insertion direction 43.

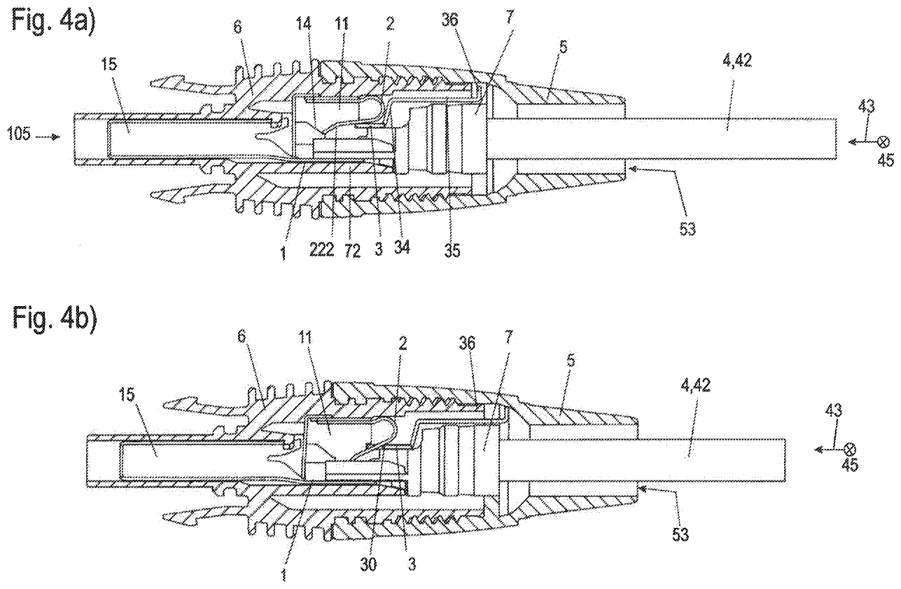

In the plug connector 10 of FIG. 4a and b, the first spring arm 22, in the delivery state L of the plug connector, is laid down on a latching ramp 14. FIG. 4a) shows this. The clamping of the electrical conductor 4, until it is in connection state A of FIG. 4b), and the renewed release of the electrical conductor 4 from the plug connector 10 otherwise also occur analogously to the embodiments of FIGS. 1 and 3.

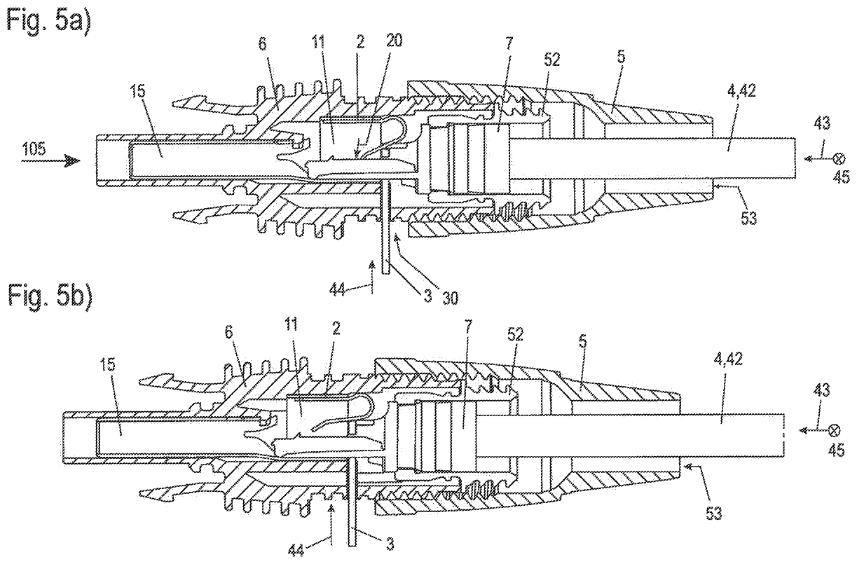

The plug connector 10 of the embodiment of FIG. 5a and b comprises a release element 3 which extends in a release direction 44 transversely to the conductor insertion direction 43 and transversely to the extension direction 45. After screwing on of the plug-connector 10, in which the sleeve-like housing end part 5 is shifted against the conductor insertion direction 43 with respect to the connection housing 6, the release element can be inserted into the connection housing through an insertion opening 30 provided in the connection housing 6. After the insertion, the release element 3 extends at least partially outside of the connection housing 6. By means of the release element, the first spring arm 22 of the clamping spring 2 can be lifted against the clamping direction 20 if a conductor 4 is clamped in the plug connector 10, in order to be able to remove said conductor against the conductor insertion direction 43.

### LIST OF REFERENCE NUMERALS

1 Electrical contact/connection device

10 Electrical plug connector

105 Plug face

11 Spring cage

13 Busbar contact region

14 Latching ramp

15 Plug face, contact sleeve

2 Clamping spring

20 Clamping direction

21 Bend

22 First spring arm

222 Free arm end

23 Second spring arm

24 Rotation axis, pin

241 Rotation direction

3 Release element

31 Holding arm

32 Cross web

321 Inner edge

33 Step

34 Pressing section

35 Extension arm

4 Electrical conductor

41 Core of the electrical conductor

42 Jacket of the electrical conductor

43 Conductor insertion direction

44 Release direction

45 Extension direction

5 Sleeve-like housing part

50 Inner space

52 Insulation insert

53 Insertion opening for the electrical conductor

55 Thread

6 Connection housing

60 Inner space

61 Latching hook

62 Link, groove

64 Tool insertion opening

65 Thread

7 Slider

71 Sleeve

72 Conductor accommodation

721 End of the conductor accommodation

73 Abutment surface

74 Supporting part

741 Support surface

742 Contact surface

743 Abutment region

75 Contact web

76 Tongue

78 Conductor insertion opening

L Delivery state

A Connection state

E Removal state

1. An electrical plug connector (10) with
a. a plug face (105) which is provided for connecting the electrical plug connector (10) to a mating plug connector,
b. an electrical contact (1) which is provided for connecting an electrical conductor (4) to the electrical plug connector (10) and which comprises a spring cage (11) with a clamping spring (2) acting as a pressure spring and a busbar contact region (13) opposite the clamping spring (2), and
c. a single-part or multipart connection housing (6) which is designed for accommodating the contact (1),
d. wherein it is provided moreover to latch engage the clamping spring (2) in a latching state in open position, wherein this latching and open position can be brought out of engagement at least by inserting the conductor,
characterized in that
e. the plug connector (10) includes a release element (3) which is provided for releasing the electrical conductor (4) from the contact (1), so that the conductor (4) can be removed from the plug connector (10), wherein the release element (3) is integrated in the plug connector (10).

2. The electrical plug connector (10) according to claim 1, characterized in that the release element (3) can be actuated manually without a tool.

3. The electrical plug connector (10) according to claim 1, characterized in that the release element (3) can be actuated manually with a tool.

4. The electrical plug connector (10) according to claim 1, 2 or 3, characterized in that the release element (3) is formed as a pivot element or on a pivot element for opening the clamping spring (2).

5. The electrical plug connector (10) according to any one of the preceding claims, characterized in that the release element (3) is formed or arranged on a shiftable slider (7) and can be moved over said slider.

6. The electrical plug connector (10) according to claim 5, characterized in that the slider (7) can be shifted parallel to a conductor insertion opening.

7. The electrical plug connector (10) according to any one of the preceding claims, characterized in that it is provided moreover that the latching and open position can also be brought out of engagement by moving the release element (3).

8. The electrical plug connector (10) according to any one of the preceding claims, characterized in that the slider (7) includes a conductor accommodation (72) for accommodating the conductor (4), wherein the conductor accommodation (72) is arranged between the busbar contact region (13) and the clamping spring (2) of the contact (1).

9. The electrical plug connector (10) according to any one of the preceding claims, characterized in that the slider (7) can be shifted from a delivery state (L), in which the electrical conductor (4) can be inserted into the spring cage (11), into a connection state (A), in which the clamping spring (2) is in contact with the electrical conductor (4) and clamps said electrical conductor in the spring cage (11), and in that the plug connector (10) can be transferred back into the delivery state (L) by means of the release element (3).

10. The electrical plug connector (10) according to any one of the preceding claims, characterized in that the clamping spring (2) can be released from the conductor, in particular taken off of it, by means of the release element (3).

11. The electrical plug connector (10) according to any one of the preceding claims, characterized in that the release element (3) is mounted in a shiftable manner in the contact (1) on the conductor insertion side of the spring cage (11).

12. The electrical plug connector (10) according to any one of the preceding claims, characterized in that the slider (7) with the electrical conductor (4) can be shifted in the conductor insertion direction.

13. The electrical plug connector (10) according to any one of the preceding claims, characterized in that the release element (3) is formed from a plate made of metal or another material.

14. The electrical plug connector (10) according to any one of the preceding claims, characterized in that the release element (3) is formed or arranged on a sleeve (71), in particular on a shiftable sleeve (71), wherein this sleeve forms the slider.

15. The electrical plug connector (10) according to any one of the preceding claims, characterized in that the plate extends at least partially in the conductor insertion direction (43) and can be shifted either
a. by shifting the slider (7) in the conductor insertion direction and/or by means of the clamping spring (2) against the conductor insertion direction (43), or
b. by means of a tool (8) in and/or against the conductor insertion direction (43), wherein the clamping spring (2) is released from the conductor (4) when the plate is shifted in the conductor insertion direction (43).

16. The electrical plug connector (10) according to any one of the preceding claims, characterized in that the release element (3) is mounted in the connection housing (6) of the plug connector (10), which is provided for accommodating the contact (1) in a movable manner, in particular in a shiftable manner.

17. The electrical plug connector (10) according to any one of the preceding claims, characterized in that the sleeve protrudes axially from the connection housing (6).

18. The electrical plug connector (10) according to any one of the preceding claims, characterized in that the plate extends at least partially in a release direction (44) transversely to the conductor insertion direction (43) and can be shifted in or against the release direction (44), wherein the clamping spring (2) is released from the conductor (4) when the plate is shifted in the release direction (44).

19. The electrical plug connector (10) according to any one of the preceding claims, characterized in that the release element (3, 23) is formed as part of the clamping spring (2) itself

20. The electrical plug connector (10) according to any one of the preceding claims, characterized in that the clamping spring (2) comprises a first spring arm (22) with a free arm end (222) which is used for clamping the electrical conductor (4) in the clamping cage (11).

21. The electrical plug connector (10) according to any one of the preceding claims, characterized in that the clamping spring (2) comprises a second spring arm (23).
